(19) United States
(12) Patent Application Publication
(10) Pub. No.: US 2025/0242914 A1
(43) Pub. Date: Jul. 31, 2025

(54) AIRCRAFT CABIN TROLLEY, AIRCRAFT GALLEY ARRANGEMENT AND AIRCRAFT

(71) Applicant: Airbus Operations GmbH, HAMBURG (DE)

(72) Inventors: Torsten TRÜMPER, HAMBURG (DE); Christopher DALLMANN, HAMBURG (DE)

(21) Appl. No.: 19/039,524

(22) Filed: Jan. 28, 2025

(30) Foreign Application Priority Data
Jan. 30, 2024 (EP) 24154863.5

(51) Int. Cl. B64D 11/00; A47B 31/02; A47B 31/06; B64D 11/04

(52) U.S. Cl. CPC B64D 11/0007; A47B 31/02; A47B 31/06; B64D 11/04

(57) ABSTRACT

An aircraft cabin trolley, including: a body with a top, a bottom, a front and a rear, wherein a door for accessing the inside of the trolley is provided at the front, which is the operator side of the trolley; an electrical cooling unit, including a compressor, an evaporator and a condenser, configured to actively cool the inside of the trolley; and a power transfer unit configured to transfer electrical power from a power source outside the trolley to the cooling unit. An aircraft galley arrangement including the aircraft cabin trolley, wherein the power transfer unit is configured to dock with a galley power transfer unit on a galley wall. An aircraft with at least one of the aforementioned.

### CROSS-REFERENCES TO RELATED APPLICATIONS

This application claims the benefit of the European Patent Application No. 24154863.5 filed on Jan. 30, 2024, the entire disclosures of which are incorporated herein by way of reference.

### FIELD OF THE INVENTION

The invention relates to an aircraft cabin trolley and an aircraft galley arrangement comprising the trolley. It further relates to an aircraft with at least one of the aircraft cabin trolley or aircraft galley arrangement comprising the trolley.

### BACKGROUND OF THE INVENTION

The current solutions for aircraft cabin trolleys and aircraft galley arrangements comprising such trolleys are different and depending on the aircraft program. The galleys always provide different designs in terms of chilled or non-chilled galleys. A chilled galley has a cold air distribution system in the lower part of the galley, trolley compartments with doors to keep the trolley compartments and the trolleys parked therein cold, a drain interface for the condensation water, and space for the installed cooling unit. In some aircraft, an air chiller is installed inside the galley beside the trolleys. The customer must abstain of the waste compartment in case of a chilled galley because the air chiller is installed around the waste compartment.

On Airbus A330 aircraft, air chillers are installed underfloor. Air ducts route the cold air between the chiller and the galley in a closed loop. This needs a lot of additional space, weight and installation effort in the aircraft.

On Airbus A350 aircraft, a very large and heavy liquid cooling loop connects each galley with the cooling system outside of the pressurized area. In the galley, cooling units are installed which use the cold liquid to cool the air within a heat exchanger. These systems have an installation weight of several hundred kilograms.

All current installations have in common that they are heavy, and that their weight is integrated into the respective aircraft, whether needed or not.

### SUMMARY OF THE INVENTION

A problem to be solved is to improve the efficiency of the cooling of aircraft cabin trolleys, in particular in combination with an aircraft galley arrangement. This includes an improvement of the comfort for the operator of such aircraft cabin trolleys.

The problem underlaying the invention is particularly solved by the following technical teachings:
(1) An aircraft cabin trolley, comprising a body with a top, a bottom, a front and a rear, wherein a door for accessing the inside of the trolley is provided at the front, which is the operator side of the trolley; an electrical cooling unit, including a compressor, an evaporator and a condenser, configured to actively cool the inside of the trolley; and a power transfer unit configured to transfer electrical power from a power source outside the trolley to the cooling unit. Such a trolley with an integrated chiller does not require a bulky central external cooling at its parking station. Due to low heat losses, only small amounts of coolant are needed per trolley. Furthermore, more sustainable coolants can be used. Also, the decentralized power supply increases the cooling power consumption.

Wheels may be connected to the bottom. The coolant used in the cooling unit may be a non-fluorinated gas. A door for accessing the inside of the trolley may be provided at the front, i.e., the operator side of the trolley. The aircraft cabin trolley, e.g., its body, may have outer dimensions corresponding to a common aircraft cabin trolley standard, such as the KSSU standard or the ATLAS standard. Waste heat from the trolley, e.g., from the condenser and/or a battery described below, may be removed at the rear of the trolley. For this purpose, a fan may be provided in the trolley or at a galley wall facing the rear of the trolley. This fan could direct the waste heat towards the galley crown, i.e., a space above an aircraft galley.
(2) The aircraft cabin trolley according to section (1), wherein the power transfer unit is an inductive power transfer unit. This improves comfort for the operator of the trolley, since the placement of the trolley in its parking position for power delivery from a power source outside the trolley can be less precise than with a power transfer unit requiring direct contact or even form-fitting contact with a power source outside the trolley, e.g., a plug and socket connection.
(3) The aircraft cabin trolley according to section (1) or (2), further comprising: a battery that is configured to be charged via the power transfer unit only when a desired cooling state of the trolley is obtained. This technical measure further improves the efficiency of the power management, improves battery life, and allows the cooling to be performed and/or continued when the trolley lacks power supply from a power source outside the trolley.
(4) The aircraft cabin trolley according to one of sections (1) to (3), wherein the battery is configured to be cooled by a fan. Thereby, battery life can be improved. Further, the air heated by the battery can be directed towards a desired location of the trolley or outside the trolley.
(5) The aircraft cabin trolley according to one of sections (1) to (4), wherein the condenser and the evaporator are directly connected to each other via a capillary tube. This is a cost-efficient solution compared to the use of an expansion valve.
(6) The aircraft cabin trolley according to one of sections (1) to (5), further comprising: a handle for an operator to move the trolley; wherein the electrical cooling unit is configured to create an airflow of air heated by the condenser during operation that is directed towards the handle of the trolley and/or that is directed along the bottom and beyond the front. Thereby, either the hands or the feet of an operator operating the trolley can be warmed, which increases the comfort for the operator.
(7) The aircraft cabin trolley according to one of sections (1) to (6), wherein the electrical cooling unit is arranged at the top. This makes it possible to bring the condenser fan in a position for blowing towards the trolley handle, and thus to improve the comfort of handling the trolley by using the waste heat for warming its handle. Also, the waste heat may be used for keeping dishes placed on top of the trolley warm.
(8) The aircraft cabin trolley according to section 7, wherein a freezer compartment is provided at the top inside the trolley.
(9) The aircraft cabin trolley according to one of sections (1) to (6), wherein the electrical cooling unit is arranged at the bottom. Such an arrangement can make the trolley more compact and help reduce the noises from compressor.
(10) The aircraft cabin trolley according to one of sections (1) to (6), wherein the electrical cooling unit is arranged at the door. This arrangement has the combined advantage of more compactness of the trolley and creating an airflow passing the condenser towards the handle for warming it, with or without a fan. Further, the condenser being close to the operator of the trolley causes heat irradiation towards the operator, which increases the comfort of the operator.
(11) An aircraft galley arrangement comprising the aircraft cabin trolley according to one of sections (1) to (10), wherein the power transfer unit is configured to dock with a galley power transfer unit on a galley wall. The benefits of this arrangement are mainly caused by the decentralized allocation of its functional units. There is no need for any additional cooling from the galley, resulting in a gain in space and an overall weight loss. Moreover, in case of malfunctioning the trolleys can easily be repaired or exchanged separately. The arrangement according to this teaching of the invention also promises great compatibility. Every aircraft without a chilled galley could be equipped with the new trolley. Only minor adaptations would be needed for the power supply. Another advantage is that the cooling system of the trolley is not based on a fluorinated gas as coolant.
(12) The aircraft cabin trolley according to one of sections 1 to 10 or the aircraft galley arrangement according to section 11, comprising a human machine interface configured to perform any combination of the following functions:
a) switching on/off the cooling unit;
b) selecting a target temperature of an inside of the trolley;
c) showing an actual temperature of an inside of the trolley; and/or
d) showing a temperature curve of a temperature of an inside of the trolley over a certain time.

This makes operation much easier, efficient, and intuitive for the operator. Further, in case of d), the cooling chain can be controlled to ensure the quality of the food stored in the trolley.
(13) An aircraft with the aircraft cabin trolley or with the aircraft galley arrangement in an aircraft galley according to one of the preceding sections.

### BRIEF DESCRIPTION OF THE DRAWINGS

The foregoing summary, as well as the following detailed description, will be better understood when read in conjunction with the appended drawings. For the purposes of illustrating the present disclosure, preferred embodiments are shown in the drawings. It should be understood, however, that the invention is not limited to the specific embodiments disclosed, and reference is made to the claims for that purpose. In the drawings:

FIG. 1A shows a side view of a trolley according to a first embodiment of the invention;

FIG. 1B shows a vertical cross-section through the trolley of FIG. 1A in a plane that is parallel to a front of the trolley;

FIG. 2A shows a side view of a trolley according to a second embodiment of the invention;

FIG. 2B shows a vertical cross-section through the trolley of FIG. 2A in a plane that is parallel to the front of the trolley;

FIG. 3 shows a side view of a trolley according to a third embodiment of the invention;

FIG. 4 shows an aircraft galley in an aircraft.

### DETAILED DESCRIPTION OF THE PREFERRED EMBODIMENTS

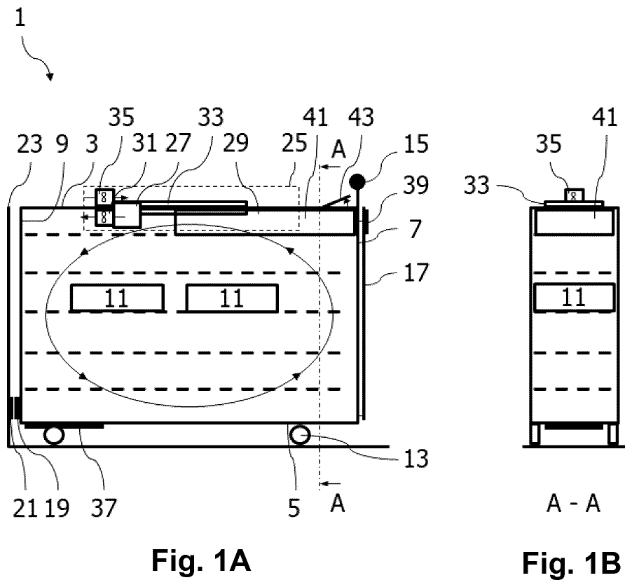

FIG. 1A shows a side view of a trolley 1 according to a first embodiment of the invention and FIG. 1B shows a vertical cross-section through the trolley 1 in a plane that is parallel to a front of the trolley 1. The trolley 1 comprises a box shaped body with a top 3, a bottom 5, a front 7, also referred to as the operator side of the trolley 1, and a rear 9 connected by two sides illustrated in the cross-section. Food and/or beverage trays 11 are located on shelves within the body of the trolley 1. The trolley 1 further comprises wheels 13 connected to the bottom 5 of the body and a handle 15 connected to the trolley 1 at the top 3 and/or front 7 of the body, allowing the trolley 1 to be moved, i.e., pushed or pulled, by an operator, such as a flight attendant. A door 17 for accessing the food and/or beverage trays 11 is provided at the front 7 of the body, and a power transfer unit 19, which here is an inductive power transfer unit 19, e.g., an induction panel, is connected to the rear 9 of the body such that the trolley 1 is configured to be placed with the power transfer unit 19 in contact with or near a corresponding galley power transfer unit 21 on a galley wall 23. The aircraft cabin trolley 1, e.g., its body, has outer dimensions corresponding to a common aircraft cabin trolley standard, such as the KSSU standard or the ATLAS standard.

The trolley has an electrical cooling unit 25, comprising the following components: a compressor 27, an evaporator 29, an evaporator fan 31, a condenser 33 and a condenser fan 35. The evaporator 29 may have a power consumption of 50 to 100 W, the condenser 33 may have a power consumption of 80 to 150 W, and each fan may have a power consumption of 1 to 5 W. While the cooling efficiency is improved using fans, a cooling effect will still be achieved using only one of the fans 31, 35 or by omitting the fans 31, 35 altogether. Here, the cooling unit 25 and its components are provided at the top 3, wherein each component can be arranged as shown in FIGS. 1A and 1B. In particular, the evaporator 29 is arranged closer to the inside of the body of the trolley 1 than the condenser 33. The evaporator fan 31 directs airflow to the evaporator 29 such that the air is cooled by the evaporator 29 and circulated in the direction shown by the four arrows of the ellipse drawn in FIG. 1A, i.e., towards the rear 9, where the airflow is diverted to the bottom 5 around the trays 11 to cause an air circulation through the whole trolley 1. On the other side, the condenser fan 35 directs airflow to the condenser 33 such that air is heated by the condenser 33 and directed towards the handle 15, thus warming the handle 15 and the hands of an operator of the trolley 1, which increases the comfort for the operator. Condensation water is evaporated at the compressor 27, so that a dedicated drain interface is not necessary.

In operation, the compressor 27 pressurizes coolant which flows to the condenser 33. There, the coolant is cooled convectively by the surrounding air. Subsequently, the coolant flows through an expansion valve or, preferably a capillary tube (both not shown), and thereby decreases in pressure and temperature, e.g., to a temperature range between 0 to 5° C. In the evaporator 29, heat transmitted from the inside of the trolley 1 warms up the coolant, which then reaches the compressor 27 to repeat the cycle. The coolant may be a non-fluorinated gas. Such gas/refrigerant causes no damage to the ozone layer and its global warming potential is non-existent or negligible.

The electric power for the compressor 27 and the fans 31, 35 comes either directly from the power transfer unit 19 and/or from an integrated battery 37, which here is arranged at the bottom 5 and closer to the rear 9 than to the front 7.

The power transfer unit 19 is equipped with an electronic control (not shown) for direct power transfer prior to charging the battery 37, when the trolley 1 is in its parking position in contact with or near a corresponding galley power transfer unit 21 on a galley wall 23, and for switching to battery power supply, when the trolley 1 leaves this parking position.

A human machine interface 39, e.g., a touch screen, is provided at the door 17. However, it can alternatively be provided at the top 3 of the trolley 1 and/or in a galley, e.g., in a galley door, and configured to perform any combination of the following functions:

switching on/off the cooling unit 25;

selecting a target temperature of an inside of the trolley 1;

showing an actual temperature of an inside of the trolley 1; and/or

showing a temperature curve of a temperature of an inside of the trolley 1 over a certain time.

Here, a freezer compartment 41 is proved at the top shelf inside the trolley 1. To access the freezer compartment 41, it may be configured as a drawer to be drawn to the front 7, once the door 17 is opened, and/or a flap 43 may be provided at the door 17 or at the top 3, wherein the latter is shown in FIG. 1.

The wall of the trolley 1, including the door 17, may be made of a vacuum insulation wall. Such a vacuum insulation wall is an evacuated gas impermeable heat insulation wall with a core material comprising or consisting of a pressed powder board of fumed silica. A vacuum insulation wall may also be used for the freezer compartment 41.

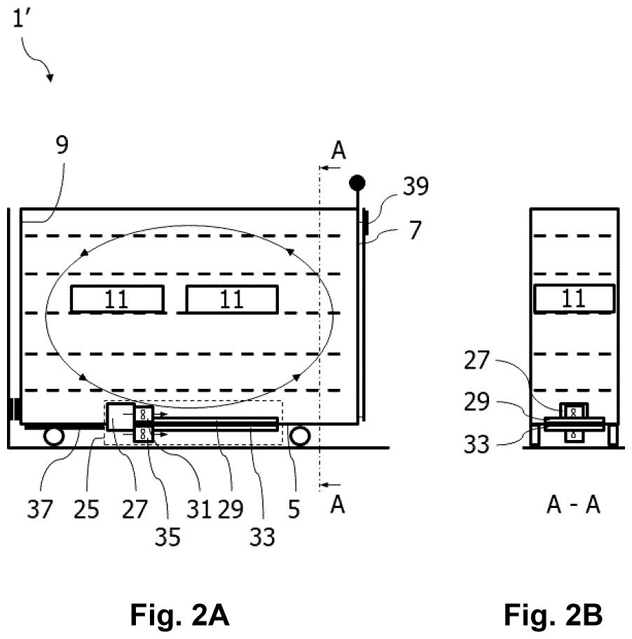

FIG. 2A shows a side view of a trolley 1′ according to a second embodiment of the invention and FIG. 2B shows a vertical cross-section through the trolley 1′ in a plane that is parallel to the front 7 of the trolley 1′.

Here, the cooling unit 25 and its components are provided at the bottom 5, wherein each component can be arranged as shown in FIGS. 2A and 2B. In particular, the evaporator 29 is arranged closer to the inside of the body of the trolley 1′ than the condenser 33. The evaporator fan 31 directs airflow to the evaporator 29 such that the air is cooled by the evaporator 29 and circulated in the direction shown by the four arrows of the ellipse drawn in FIG. 2A, i.e., towards the front 7, where the airflow is diverted to the top 3 around the trays 11 to cause an air circulation through the whole trolley 1′. On the other side, the condenser fan 35 directs airflow to the condenser 33 such that air is heated by the condenser 33 and directed towards the front 7, thus warming the feet of an operator of the trolley 1′. The condenser fan 35 may be configured to draw air surrounding the battery 37, thus cooling the battery 37. In fact, the condenser fan 35 may be placed such, e.g., closer to the rear 9 than the battery 37, that its airflow first reaches the battery 37 and then the condenser 33. Further, the condenser fan 35 may direct an airflow of air heated by the condenser 33 during operation that is directed towards the operator side of the trolley 1′, thus creating a warm airflow along the bottom 5 and beyond the front 7, thereby warming the feet of an operator of the trolley 1, which increases the comfort for the operator. In a modification, part of the airflow may be directed upwards towards the handle 15 to further achieve the effect described in the first embodiment. Condensation water is evaporated at the compressor 27, so that a dedicated drain interface is not necessary.

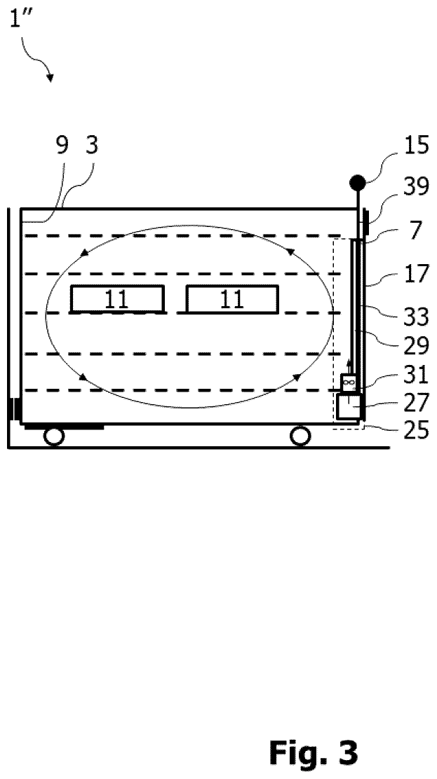

FIG. 3 shows a side view of a trolley 1″ according to a third embodiment of the invention.

Here, the cooling unit 25 and its components are provided at the front 7, e.g., are integrated in the door 17, wherein each component can be arranged as shown in FIG. 3. While FIG. 3 does not show a condenser fan, such a condenser fan can readily be provided as in the other two embodiments. In particular, the evaporator 29 is arranged closer to the inside of the body of the trolley 1″ than the condenser 33. The evaporator fan 31 directs airflow to the evaporator 29 such that the air is cooled by the evaporator 29 and circulated in the direction shown by the four arrows of the ellipse drawn in FIG. 3, i.e., towards the top 3, where the airflow is diverted to the rear 9 around the trays 11 to cause an air circulation through the whole trolley 1″. On the other side, air is heated by the condenser 33 and rises upwards towards the handle 15, thus warming the handle 15 and the hands of an operator of the trolley 1″, which increases the comfort for the operator. Condensation water is evaporated from the compressor 27, so that a dedicated drain interface is not necessary.

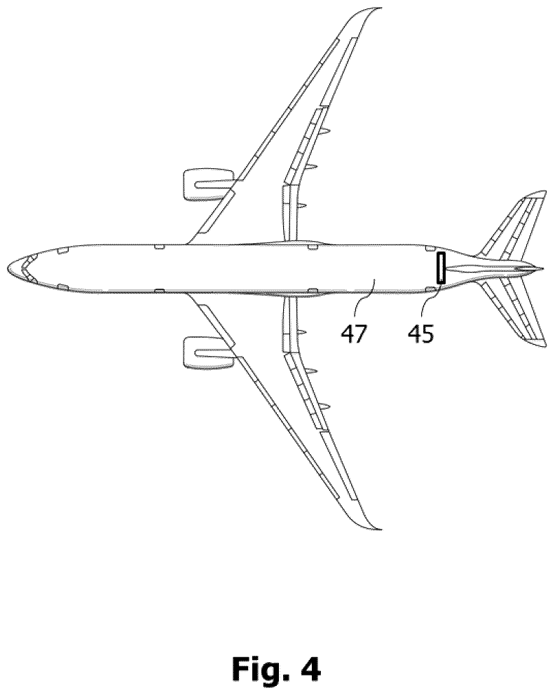

FIG. 4 shows an aircraft galley 45 in an aircraft 47, wherein the trolley 1, 1′, 1″ is configured to be parked in a compartment of the aircraft galley 45.

In another embodiment, which is not shown in the figures, waste heat from the trolley, e.g., from the condenser 33 and/or the battery 37, may be removed at the rear 9 of the trolley. For this purpose, a fan (not shown) may be provided in the trolley or at the galley wall 23 facing the rear 9 of the trolley. This fan could direct the waste heat towards the galley crown, i.e., a space above the aircraft galley 45.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft cabin trolley, comprising:
a body with a top, a bottom, a front and a rear, wherein a door for accessing the inside of the trolley is provided at the front, which is an operator side of the trolley;
an electrical cooling unit, including a compressor, an evaporator and a condenser, configured to actively cool the inside of the trolley; and
a power transfer unit configured to transfer electrical power from a power source outside the trolley to the cooling unit.

2. The aircraft cabin trolley according to claim 1, wherein the power transfer unit is an inductive power transfer unit.

3. The aircraft cabin trolley according to claim 1, further comprising a battery configured to be charged via the power transfer unit only when a desired cooling state of the trolley is obtained.

4. The aircraft cabin trolley according to claim 3, wherein the battery is configured to be cooled by a fan.

5. The aircraft cabin trolley according to claim 1, wherein the condenser and the evaporator are directly connected to each other by means of a capillary tube.

6. The aircraft cabin trolley according to claim 1, further comprising:
a handle for an operator to move the trolley;
wherein the electrical cooling unit is configured to create an airflow of air heated by the condenser during operation that is directed towards the handle of the trolley, that is directed along the bottom and beyond the front or is both directed towards the handle of the trolley and directed along the bottom and beyond the front.

7. The aircraft cabin trolley according to claim 1, wherein the electrical cooling unit is arranged at the top.

8. The aircraft cabin trolley according to claim 7, wherein a freezer compartment is proved at the top, inside the trolley.

9. The aircraft cabin trolley according to claim 1, wherein the electrical cooling unit is arranged at the bottom.

10. The aircraft cabin trolley according to claim 1, wherein the electrical cooling unit is arranged at the door.

11. An aircraft galley arrangement comprising the aircraft cabin trolley according to claim 1, wherein the power transfer unit is configured to dock with a galley power transfer unit on a galley wall.

12. The aircraft cabin trolley according to claim 1, comprising a human machine interface configured to perform any combination of the following functions:
switching on/off the cooling unit;
selecting a target temperature of an inside of the trolley;
showing an actual temperature of an inside of the trolley; or
showing a temperature curve of a temperature of an inside of the trolley over a certain time.

13. The aircraft galley arrangement according to claim 11, comprising a human machine interface configured to perform any combination of the following functions:
switching on/off the cooling unit;
selecting a target temperature of an inside of the trolley;
showing an actual temperature of an inside of the trolley; or
showing a temperature curve of a temperature of an inside of the trolley over a certain time.

14. An aircraft with the aircraft cabin trolley according to claim 1.

15. An aircraft with the aircraft galley arrangement in an aircraft galley according to claim 11.
